(19) United States
(12) Patent Application Publication
(10) Pub. No.: US 2005/0073788 A1
(43) Pub. Date: Apr. 7, 2005

(54) Integrated circuit outputs protection during JTAG board tests

(76) Inventor: Chananiel Weinraub, Herzliya (IL)

Correspondence Address: TEXAS INSTRUMENTS INCORPORATED, P O BOX 655474, M/S 3999, DALLAS, TX, 75265, US

(21) Appl. No.: 10/712,660

(22) Filed: Nov. 13, 2003

Related U.S. Application Data
(60) Provisional application No. 60/508,503, filed on Oct. 3, 2003.

(51) Int. Cl. H02H 7/00

(52) U.S. Cl. 361/100

(57) ABSTRACT

A technique is provided for implementing device/chip outputs protection during JTAG circuit board testing. A protection circuit detects a short or overload on every output pin; and within a short time (i.e. 1 clock cycle) disables the output-enable signal of the associated output buffer only during tests using the JTAG circuitry (IEEE 1149.1). A protection register is connected to the TAP controller for analysis to point to the exact failure location.

### RELATED PATENT APPLICATIONS

This application claims the benefit, under 35 U.S.C. §119(e)(1), of U.S. Provisional Application No. 60/508,503, Attorney Docket No. TI-35491PS, entitled IC Device Outputs Protection During JTAG Board Tests, filed Oct. 3, 2003 by Chananiel Weinraub.

### BACKGROUND OF THE INVENTION

1. Field of the Invention

This invention relates generally to integrated circuit (IC) testing, and more particularly to a technique for providing IC outputs protection during JTAG circuit board testing.

2. Description of the Prior Art

The most widely accepted test standard for integrated circuits is IEEE Standard 1149.1, also known as JTAG. This standard was created with the primary goal of alleviating board-test problems via test access ports (TAPS). Widespread acceptance of JTAG in the electronics and semiconductor industry requires current and future IC's to be fully compliant with this standard.

Following assembly of a particular device/chip on a printed circuit board, a short circuit to power/ground or to another device/chip's outputs may exist that cannot be seen under BGA packages. The connectivity is then checked using JTAG circuitry; but since the JTAG boundary scan chain is usually long, it may take thousands of clock cycles for the test software to detect the short. This long duration of a short state may damage a good device/chip, and therefore lead to customer returns and tedious and costly failure analysis procedures for investigating the cause of the failure(s).

In view of the foregoing, it would be both beneficial and advantageous to provide a technique for providing IC outputs protection during JTAG circuit board testing.

### SUMMARY OF THE INVENTION

To meet the above and other objectives, the present invention provides a technique for implementing device/chip outputs protection during JTAG circuit board testing. A protection circuit detects a short or overload on every output pin; and within a short time (i.e. 1 clock cycle) disables the output-enable signal of the associated output buffer only during tests using the JTAG circuitry (IEEE 1149.1). A protection register is connected to the TAP controller for analysis to point to the exact failure location.

According to one embodiment, an integrated circuit (IC) device outputs test protection circuit comprises decision circuitry responsive to predetermined boundary scan register (BSR) signals and a test access port (TAP) controller mode signal to generate a first logic signal; a test protection circuit register responsive to the first logic signal, a test clock and a TAP controller instruction to generate a second logic signal; and logic circuitry responsive to at least one BSR signal and the second logic signal to generate a protection circuit output control signal, wherein the protection circuit output control signal operates within one test clock cycle to disable an output buffer associated with a short circuit corresponding to the IC device.

According to another embodiment, an integrated circuit (IC) device outputs test protection circuit comprises means responsive to predetermined boundary scan register (BSR) signals and a test access port (TAP) controller mode signal for generating a first logic signal; means responsive to the first logic signal, a test clock and a TAP controller instruction for generating a second logic signal; and means responsive to at least one BSR signal and the second logic signal for generating a protection circuit output control signal, wherein the protection circuit output control signal operates within one test clock cycle to disable an output buffer associated with a short circuit corresponding to the IC device.

According to yet another embodiment, a method of providing integrated circuit (IC) device outputs protection during JTAG board tests comprises the steps of 1) providing an IC device outputs test protection circuit including decision circuitry responsive to predetermined boundary scan register (BSR) signals and a test access port (TAP) controller mode signal to generate a first logic signal; a test protection circuit register responsive to the first logic signal, a test clock and a TAP controller instruction to generate a second logic signal; and logic circuitry responsive to at least one BSR signal and the second logic signal to generate a protection circuit output control signal; and 2) generating the protection circuit output control signal within one test clock cycle to disable an output buffer associated with a short circuit condition or overload condition corresponding to an IC device.

### BRIEF DESCRIPTION OF THE DRAWINGS

Other aspects and features of the present invention and many of the attendant advantages of the present invention will be readily appreciated, as the invention becomes better understood by reference to the following detailed description when considered in connection with the accompanying drawing figures thereof and wherein:

FIG. 1 is a diagram illustrating JTAG usage (IEEE 1149.1) well known in the art;

FIG. 2 is a Device top level architecture diagram illustrating the BSRs in the JTAG level according to one embodiment of the present invention;

FIG. 3 is a simplified block diagram illustrating the protection circuitry portion of the test system architecture shown in FIG. 2; and

FIG. 4 is a more detailed circuit diagram illustrating the protection circuitry portion of the test system architecture shown in FIGS. 2 and 3.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

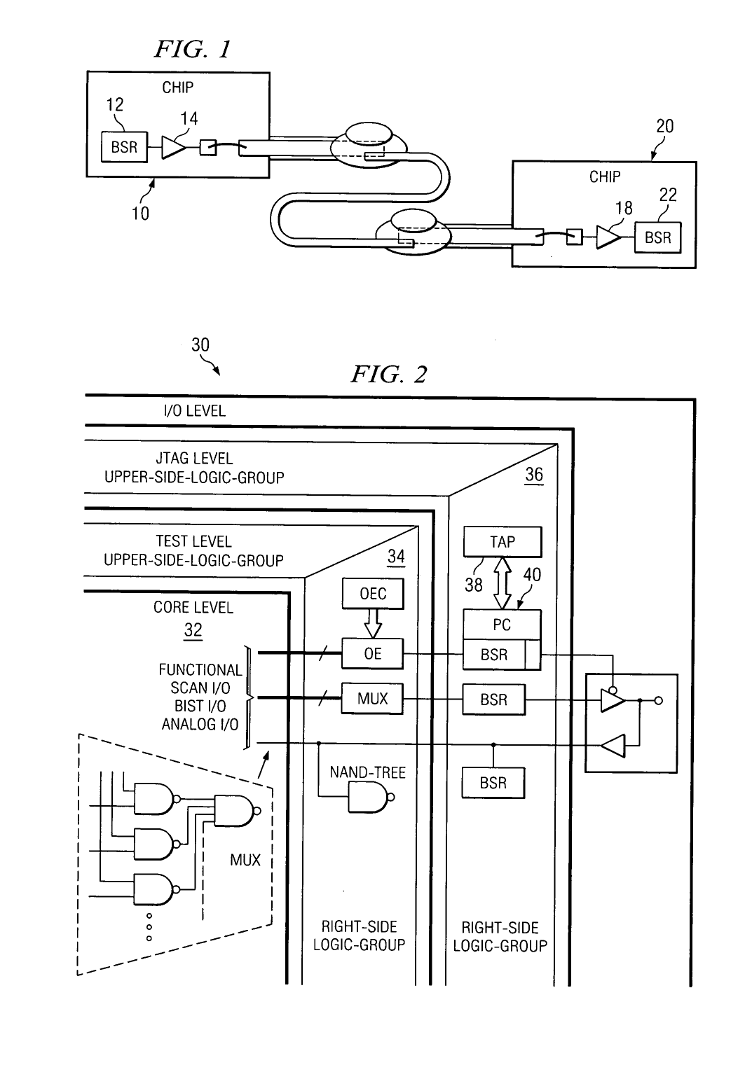

The most widely accepted test standard for integrated circuits is IEEE Standard 1149.1, also known as JTAG, as stated herein before. This standard, as also stated herein before, was created with the primary goal of alleviating board-test problems via test access ports (TAPS); and widespread acceptance of JTAG in the electronics and semiconductor industry requires current and future IC's to be fully compliant with this standard. Looking now at FIG. 1, a diagram illustrates JTAG usage (IEEE 1149.1) that is well known in the art. With continued reference to FIG. 1, a first chip 10 including a boundary scan register (BSR) 12 has a JTAG compliant primary output buffer 14 connected to JTAG compliant primary input buffer 18 associated with a second chip 20 including a boundary scan register (BSR) 22.

Looking now at FIG. 2, a device top levels architecture 30 is shown as the BEST recommended top levels architecture for ANY device , containing one embodiment of the present invention. Device architecture 30 can be seen to include a core level 32 that implements functional, scan I/O, BIST I/O and analog I/O features. These features are the functionality of the device and additional Design For Test (DFT) logic, used to implement the desired test level 34 features such as output enable, multiplexing and I/O selection. Test level 34 logic is then employed to access the desired JTAG level 36 BSR's, each associated with its respective core. Protection circuitry 40 is shown associated with a particular BSR.

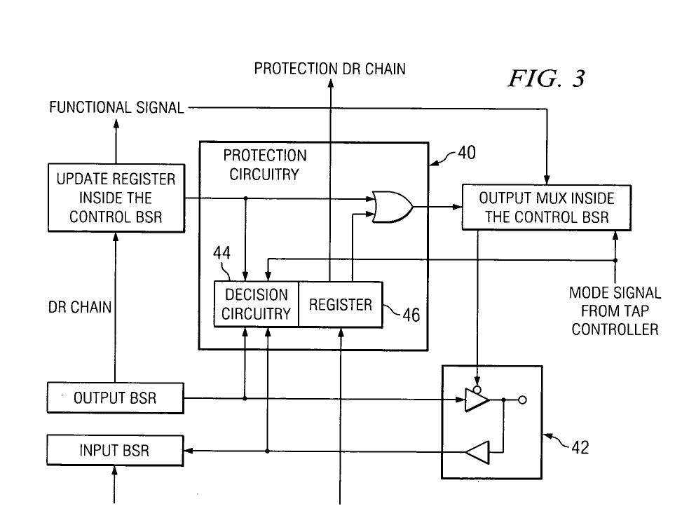

FIG. 3 is a simplified block diagram more fully illustrating the protection circuitry 40 portion in the JTAG level of the device architecture 30 shown in FIG. 2. When a short is indicated, the protection circuitry 40 will operate to disable the output-enable of the corresponding output buffer 42 within one clock cycle of the timing clock or in response to another control signal from the Decision Circuitry 44. In this way, output protection is obtained without any additional delay during a functional mode. The exact short location can be read from the Protection Register 46 that is connected to the TAP controller 38 seen in FIG. 2. Most preferably, the Protection Register 46 can be cleared while reading if for analysis purposes.

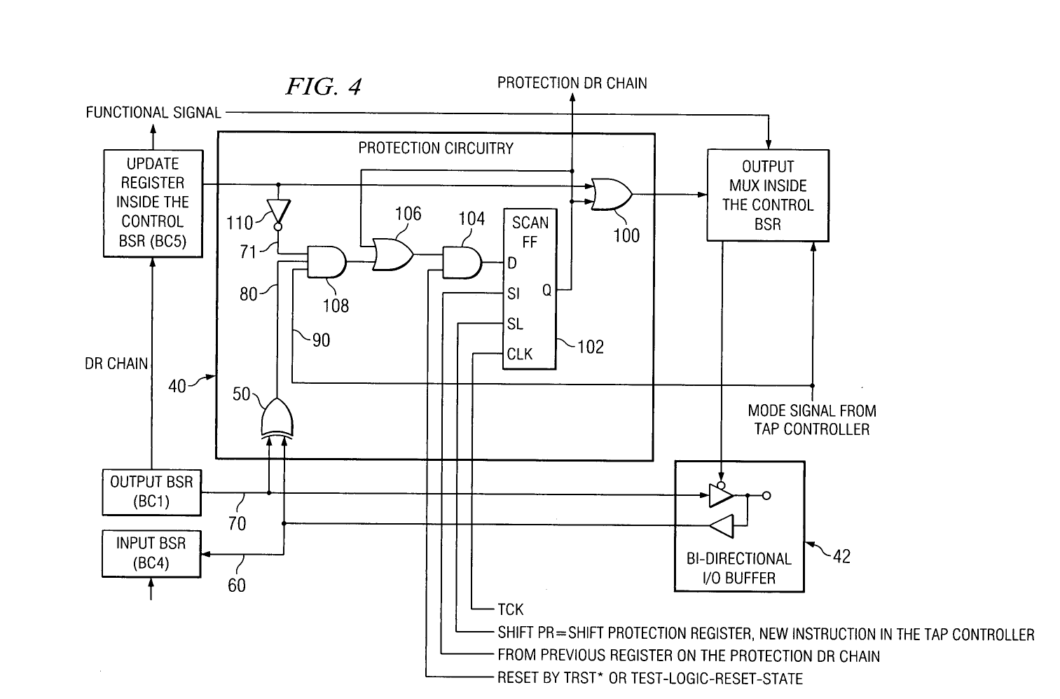

FIG. 4 is a more detailed circuit diagram illustrating the protection circuitry 40 portion of the device architecture 30 shown in FIGS. 2 and 3. It can be appreciated that if the Decision Circuitry 44 is implemented using a simple XOR gate 50, then the inputs/outputs 60, 70 to be protected should use a bi-directional buffer 42 such as shown in FIGS. 2-4. The present invention is not so limited however, and it shall be understood that the Decision Circuitry 44 shown in FIGS. 3 and 4 may also be 10 implemented, for example, using an output current sense. Most preferably, the protection circuitry 40 will be activated upon the following conditions during JTAG tests:
1) following an update data register 71 inside the control BSR enabling the output;
2) Decision Circuitry 44 indication 80 of a short or overload; and
3) a mode signal 90 from the TAP (test access port) controller (enumerated 38 in FIG. 2) enabling the control BSR.

With continued reference to FIG. 4, protection circuitry 40 can be seen to have an OR gate 100. OR gate 100 operates to enable the protection flip-flop 102, to force a tri-state (‘Z’-State) on the output buffer 42 (by disabling the output-enable input of the output buffer 42). The OR gate may have a third input connected to signal Shift-PR coming from the TAP controller (enumerated 38 in FIG. 2), in order to force a tri-state (‘Z’-State) on the output buffer 42 during the SHIFT of the Data from the protection flip-flop 102

Protection flip-flop 102 is implemented to capture a failure condition on its ‘D’-input and to shift out the value to indicate the failure; and thus the failure location (pin number) can be determined.

AND gate 104 is employed to reset/clear the protection flip-flop 102 when a ‘TRST*’ signal is active(=‘0’), or when the TAP controller 38 is in a ‘Test-Logic-Reset-State’.

OR gate 106 functions to enable the protection flip-flop 102, to maintain/lock its present state/value.

A 3-input AND gate 108 continuously checks for 3 conditions to occur, in order to indicate a failure:

Condition 1: after TAP-Update DR is enabling the primary output buffer 42

Condition 2: Decision Circuitry 44 indication of a short or overload from Exclusive OR gate 50; and

Condition 3: Mode signal from the TAP Controller 38 enables the Control BSR.

Exclusive OR Gate 50, as stated herein before, functions to detect a short or overload of the output buffer 42, by comparing the output value that is being driven by the output buffer, with the value from the input buffer. In this implementation, any mismatch will be detected by the XOR Gate 50. Other implementations can also be employed, as stated herein before. Such implementations may use current-sensing circuitry, for example, in the output buffer 42 (without the need for an input buffer).

An inverter gate 110 operates to invert the TAP-Update DR signal in order to create ‘Condition 1’ to be used by the 3-input AND gate 108.

In view of the above, it can be seen the present invention presents a significant advancement in the art of JTAG board testing. Further, this invention has been described in considerable detail in order to provide those skilled in the JTAG board test art with the information needed to apply the novel principles and to construct and use such specialized components as are required. In view of the foregoing descriptions, it should further be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow. The embodiments described herein before, for example, have assumed the usage of an output buffer 42 that has an active-low output-enable input. Other types of output buffers can just as easily be employed so long as the particular implementation is modified accordingly to provide the desired results in accordance with the inventive principles described herein above.

1. An integrated circuit (IC) device outputs test protection circuit comprising:
decision circuitry responsive to predetermined boundary scan register (BSR) signals and a test access port (TAP) controller mode signal to generate a first logic signal;
a test protection circuit register responsive to the first logic signal, a test clock and a TAP controller instruction to generate a second logic signal; and
logic circuitry responsive to at least one BSR signal and the second logic signal to generate a protection circuit output control signal, wherein the protection circuit output control signal operates within one test clock cycle to disable an output buffer associated with a short circuit corresponding to the IC device.

2. The IC device outputs test protection circuit according to claim 1, wherein the predetermined BSR signals comprise a primary input buffer signal, an output BSR signal and a control BSR update register control signal.

3. The IC device outputs test protection circuit according to claim 2, wherein the decision circuitry comprises exclusive OR circuitry operational to receive the primary input buffer signal and the output BSR signal.

4. The IC device outputs test protection circuit according to claim 1, wherein the test protection circuit register is further responsive to a previous protection data register (DR) associated with a corresponding protection DR chain to generate the second logic signal.

5. An integrated circuit (IC) device outputs test protection circuit comprising:
means responsive to predetermined boundary scan register (BSR) signals and a test access port (TAP) controller mode signal for generating a first logic signal;
means responsive to the first logic signal, a test clock and a TAP controller instruction for generating a second logic signal; and
means responsive to at least one BSR signal and the second logic signal for generating a protection circuit output control signal, wherein the protection circuit output control signal operates within one test clock cycle to disable an output buffer associated with a short circuit corresponding to the IC device.

6. The IC device outputs test protection circuit according to claim 5, wherein the means for generating a first logic signal comprises decision circuitry.

7. The IC device outputs test protection circuit according to claim 5, wherein the means for generating a second logic signal comprises a test protection circuit register.

8. The IC device outputs test protection circuit according to claim 7, wherein the test protection circuit register is further responsive to a previous protection data register (DR) associated with a corresponding protection DR chain to generate the second logic signal.

9. The IC device outputs test protection circuit according to claim 5, wherein the means for generating a protection circuit output control signal comprises logic circuitry.

10. The IC device outputs test protection circuit according to claim 5, wherein the predetermined BSR signals comprise a primary input buffer signal, an output BSR signal and a control BSR update register control signal.

11. The IC device outputs test protection circuit according to claim 10, wherein the means for generating a first logic signal comprises exclusive OR circuitry operational to receive the primary input buffer signal and the output BSR signal.

12. A protection circuit operational to prevent damage to a good device during JTAG final testing of a circuit board that employs the good device.

13. The protection circuit according to claim 12, comprising logic circuitry responsive to predetermined BSR signals to generate a protection circuit output control signal that operates within one test clock cycle to disable an output buffer associated with a short circuit or overload condition corresponding to the good device.

14. The protection circuit according to claim 13, wherein the predetermined BSR signals comprise a primary input buffer signal, an output BSR signal and a control BSR update register control signal.

15. The protection circuit according to claim 12, comprising:
decision circuitry responsive to predetermined boundary scan register (BSR) signals and a test access port (TAP) controller mode signal to generate a first logic signal;
a test protection circuit register responsive to the first logic signal, a test clock and a TAP controller instruction to generate a second logic signal; and
logic circuitry responsive to at least one BSR signal and the second logic signal to generate a protection circuit output control signal, wherein the protection circuit output control signal operates within one test clock cycle to disable an output buffer associated with a short circuit corresponding to the IC device.

16. The protection circuit according to claim 15, wherein the predetermined BSR signals comprise a primary input buffer signal, an output BSR signal and a control BSR update register control signal.

17. The protection circuit according to claim 16, wherein the decision circuitry comprises exclusive OR circuitry operational to receive the primary input buffer signal and the output BSR signal.

18. The protection circuit according to claim 15, wherein the protection circuit register is further responsive to a previous protection data register (DR) associated with a corresponding protection DR chain to generate the second logic signal.

19. The protection circuit according to claim 12, comprising:
means responsive to predetermined boundary scan register (BSR) signals and a test access port (TAP) controller mode signal for generating a first logic signal;
means responsive to the first logic signal, a test clock and a TAP controller instruction for generating a second logic signal; and
means responsive to at least one BSR signal and the second logic signal for generating a protection circuit output control signal, wherein the protection circuit output control signal operates within one test clock cycle to disable an output buffer associated with a short circuit corresponding to the IC device.

20. The IC device outputs test protection circuit according to claim 19, wherein the means for generating a first logic signal comprises decision circuitry.

21. The IC device outputs test protection circuit according to claim 19, wherein the means for generating a second logic signal comprises a test protection circuit register.

22. The IC device outputs test protection circuit according to claim 21, wherein the test protection circuit register is further responsive to a previous protection data register (DR) associated with a corresponding protection DR chain to generate the second logic signal.

23. The IC device outputs test protection circuit according to claim 19, wherein the means for generating a protection circuit output control signal comprises logic circuitry.

24. The IC device outputs test protection circuit according to claim 19, wherein the predetermined BSR signals comprise a primary input buffer signal, an output BSR signal and a control BSR update register control signal.

25. The IC device outputs test protection circuit according to claim 24, wherein the means for generating a first logic signal comprises exclusive OR circuitry operational to receive the primary input buffer signal and the output BSR signal.

26. A method of providing integrated circuit (IC) device outputs protection during JTAG board tests, the method comprising the steps of:
providing an IC device outputs test protection circuit including decision circuitry responsive to predetermined boundary scan register (BSR) signals and a test access port (TAP) controller mode signal to generate a first logic signal; a test protection circuit register responsive to the first logic signal, a test clock and a TAP controller instruction to generate a second logic signal; and logic circuitry responsive to at least one BSR signal and the second logic signal to generate a protection circuit output control signal; and
generating the protection circuit output control signal within one test clock cycle to disable an output buffer associated with a short circuit condition or overload condition corresponding to an IC device.
